(19) United States
(12) Patent Application Publication
(10) Pub. No.: US 2005/0136904 A1
(43) Pub. Date: Jun. 23, 2005

(54) Usage of cellular phones to announce/notify timings of muslim prayers

(76) Inventor: Qirfiraz Ahmed Siddiqui, Castro Valley, CA (US)

Correspondence Address: Qirfiraz A. Siddiqui, 1752 Knox Street, Castro Valley, CA, 94546, US

(21) Appl. No.: 10/788,614

(22) Filed: Feb. 27, 2004

Related U.S. Application Data
(60) Provisional application No. 60/531,839, filed on Dec. 22, 2003.

(51) Int. Cl. H04M 3/00

(52) U.S. Cl. 455/418; 455/456.6

(57) ABSTRACT

The system & method for usage of electronically stored, dynamically up-dated physical location parameters of cellular-phone or similar Mobile Device 20 to inform/alert/announce to its subscriber about the location-dependent variable timings of five-times-daily Islamic prayers called Salaat (Arabic) or Namaaz (Urdu). The alert/information can be through textual message or through formal vocal announcement called Azaan. The system allows the Azaan-time-deciding-algorithm 85 to be stored on the Mobile Device 20 or on some remotely-connected Web-server based Azaan Software Application 40, and the actual calculation may either be done dynamically just before the announcement, or the timings may be looked-up from pre-calculated location-specific look-up tables 80. The system further allows the location variables to be stored-on/retrieved-from the hand-held-mobile-device 20, itself or on some other remotely-connected computer called location-server 30. The format/accuracy of location parameters varies with the network-providers, but CELL-ID is the commonly used parameter by all cellular network technologies which rely on Cellular Base Station 25 for connectivity to the Mobile Device 20. However other location-describing formats like TA, EFLT, GPS, AGPS, TDOA, AOA, AFLT, EOTD, etc. may also be used to calculate and/or announce the Azaan-timings. The system further allows transmittal of highly personalized notification to individual subscribers by storing personal preferences in a Subscribers Database 70 which is accessible to the Azaan-Software application 40 which employs the algorithm for dynamic notification 85, and thus personal preferences for different juristic methods, and selected modes of announcements can be accommodated.

### CROSS-REFERENCE TO RELATED APPLICATIONS

This application is entitled to the benefit of Provisional Patent Application Ser. No. 60/531,839, filed on 22^{nd} December, 2003.

### STATEMENT REGARDING FEDERALLY SPONSORED RESEARCH AND DEVELOPMENT: not applicable

### BACKGROUND

It is obligatory for followers of Islamic faith, to perform specific prayers, during five slices of time within a day. In Islamic countries, each of these slices of time is started by a loudly pronounced call for prayers from the neighborhood mosque. This prayer call is called Azaan (Urdu/Persian) or Athaan/Adhaan (Arabic).

The timings for these five prayer-calls are calculated/determined from the Sunrise & Sunset timings at the specific location of each neighborhood. Thus these timings are a complex function of positional parameters like longitude, latitude and altitude, as well as the temporal parameters of date, month & the year. For example, within San Francisco Bay Area in California, the Azaan timings in San Jose locality, are different from the timings in Oakland area. And these timings keep drifting up & down from day to day. FIG. (1) is a printout from Frequently Asked Questions at the website www.islamicfinder.org, the printout explains some factors used by different juristic methods, for the calculation of prayer timings.

### BACKGROUND—FIELD OF INVENTION

Location Based Services for mobile wireless telecommunication network users. Location Based Service or LBS, is the ability to find the geographical location of a mobile device and provide services based on this location information. (455/456.3)

### BACKGROUND—DESCRIPTION OF PRIOR ART

An age-old solution for this problem was to pre-calculate and tabulate the timings for each location for the whole year. It is common practice to have these large tables posted on notice-boards/walls in mosques. However these tables are valid only within a radius of 10-20 miles from the center whereby sunrise & sunset timing are calculated.

As early as 1998, computer programs were developed which will calculate prayer timings after the manual input of some location parameter(s). Some of these freeware-software, once calibrated for a specific location, were even programmed to keep on playing Azaan at the calculated timings for that specific location. The Azaan timings calculator softwares, developed by www.islamsoft.com, and www.islamicfinder.org are popular examples of these programs. This works fine for a single location except that the whole computer has to remain powered-up which consume a lot of wattage.

More recently, during 2002-2003, alarm-clock sized time-pieces have been developed which perform the same functions as of the-above-mentioned computer program. Location parameters are normally entered, from a look-up-table, as a specific number for each city, and the number eventually translates into longitude & latitude of the city, and these positional parameters are used to determine Azaan timings for that particular city. A popular website http://onlineislamicstore.com sells many variations of these clocks. A typical description of these prior arts goes like:

“This modern Azaan clock is not only a decorative and stylish piece for your home or office, but also combines the usefulness of a full Azaan alarm to remind you of prayer timings of all 5 prayers. Fully automatic function takes the hassle out of setting and resetting the accurate timings for prayers throughout the year. You just set your local time and your city code given in the guide book which comes with the clock, and the clock will set the prayer timings automatically. This clock will even find the Qibla direction for you. You can either use it as a desktop clock or hang it on a wall Main features include automatic five times full Azaan, 400 cities Azaan times and world times, Hijri and Georgian calendars, Thermometer, Daily alarm, Auto alarm, Snooze, Daylight saving time function, Qiblah direction finder and Volume control”

These clocks are light-weight battery-operated devices, so the problem of portability and power consumption have been overcome. Still the location parameters have to be entered manually with the change of each location. However these watches have become quite popular probably due to better marketing techniques.

Although, as early as 1993, a much superior version of these watches was developed by a British company Frazer-Nash, but it failed to gain general acceptance possibly due to its rigid design. Certain salient features of “The Adhan Superclock” developed by Kamal Siddiqui of Frazer-Nash, have been described at company's web-site “www.frazer-nash.com”. Although, the company brochure claims that their product “calculates and calls the Adhan 5 times a day at the right time anywhere in the world.”, but a closer look will reveal that this product clearly lacks the flexibility required by the complexity caused by the differing juristic methods used by different schools of thoughts within Islamic faith, as depicted by FAQ in FIG (1). For example the “right time” of “Asr prayer” for a follower of Hanafi method will be different from the “right time” for a follower of Malki or Hanbali juristic method.

Also there are some other minor personal preferences for which this product makes no provision. Being a stand-alone machine, the calculation method itself is claimed to be based on a “complex astronomical simulation” which can only provide a rough location estimate having an error margin of hundreds of miles, while in comparison, present day satellite-based location-specific positioning technologies can locate an object within a range of just few meters. Although the Frazer-Nash company still markets its superclock®, but the city-based solution has clear advantages over it in terms of accuracy and flexibility.

However, the city-based solution has the disadvantage of dependence on manual entry, while ALL of the prior art have the disadvantage of being a separate piece of equipment which has to be specifically carried from place to place.

Given below is a summary of prior art's disadvantages:

Pure Software Solutions:

consume a lot of power as they run on general purpose computer which has to remain switched-on
require manual input of location parameter
can not be transported, i-e suitable for one location only.
Manual re-entry of location parameter if the computer is moved at considerable distance.
An error in local computer's time-keeping in miscalculated Azaan-timings.
   City-based clock solution:
requires manual input of city-code
The number of supported cities will remain to be a finite number.
Timings for rural areas will always be an approximation to the nearest supported city.
It requires separate power-supply, which even in the shape of re-chargeable batteries, has to separately re-charged and maintained.
It is a separate piece of equipment which needs to be carried from place to place.
On changing location, city-code has to be re-entered manually.
Local time is manually set, and an error in local time will produce an equal margin of error in Calculated azaan timings.
   Frazer-Nash's astronomical-simulation based superclock®:
is very rigid in design, and can not accommodate different juristic methods
astronomical simulation model is sensitive to changes in solar system like magnetic storms on the solar surface, etc, or even to some strong electro-magnetic noise in the neighborhood.
astronomical simulation, by definition, can give a very approximate result valid for an area ranging several hundred miles in radius, while in comparison, present day satellite-based location-specific positioning technologies can locate an object within a range of just few meters
It is a separate piece of equipment which needs to be carried from place to place.
It requires separate power-supply, which even in the shape of re-chargeable batteries, has to separately re-charged and maintained.
Again, here, the calculations are based on manually set local time which is prone to error.

### SUMMARY

My Solution: Usage of Cellular phones or similar location-sensitive hand-held-wirelessly-connected mobile devices, for real-time announcement/notification of date-and-location-dependent timings of Muslim prayer (Salaat or Salaah in Arabic, and Namaaz in Urdu/Persian), performed at five different times during the day. The software application containing the calculation algorithm may reside on a remotely connected computer or alternately may be embedded-inside or downloaded-onto the mobile device

Objects & Advantages:

Automatic detection of Location parameters. In order to maintain connectivity, the mobile network has to keep record of the current location of the mobile user. Each cell has ONE base station and the “CELL ID” is also base station's id, which is passed and known through out carrier infra-structure. Thus no manual input of any sort of location parameters are required, because it is inherently known to the Wireless Service Provider's system.
No Local time-keeping is required. In my system, Azaan timings calculations are based on the standard time which is centrally maintained at a web-server. Thus my system is free from errors caused due to manually set local time-keeping.
No separate equipment is required to be carried. Now-a-days, everybody carries a cell-phone. It has become as necessary as wrist watch. My system just uses this device which is already there.
Flexibility in method of notification. Modern cellular phones are capable of playing multimedia files, and a recorded recital of Azaan can be used to notify the subscriber, in addition to text-based notification.
Low power operation. Cellular phones are low power devices because they only communicate through base stations which are located within the cells. My Azaan-notification system uses the same connectivity procedures. In order to save more power, a subscriber may opt to be notified through textual message instead of multimedia notification.
Support for juristic methods. Software implementation can handle different juristic methods. Subscriber may opt for preferred juristic method for timing calculation and the software can be programmed to notify accordingly.
Accurate calculation of location-dependent timings. “Cells” are typically spaced around 1-2 miles apart but can be spaced up to 20 miles apart. A typical Azaan-neighborhood is also around 15-20 miles in radius, which means Azaan-timings within this radius can be estimated to remain un-changed. Therefore, the location parameter of “Cell ID” has been found to provide sufficient precision for Azaan-timings calculation purposes.
No Modification to existing system is required. The greatest advantage of my solution is that it requires no modification to the existing cellular networks or to the mobile device itself.

### DRAWING FIGURES

FIG (1): A printout from “Frequently Asked Questions” FAQs at the website www.islamicfinder.org, the printout explains some factors used by different juristic methods, for the calculation of prayer timings.

FIG (2): Main components of preferred embodiment of the system for usage of cellular phones to announce/notify timings of Muslim prayers.

FIG (3): Components of Web-Server based Software Application

FIG (4): Flow Chart for Web-Server based Software Application—Scheduling Thread

FIG (5): Flow Chart for Web-Server based Software Application—Announcing Thread

### LIST OF REFERENCE NUMERALS IN DRAWINGS

20 Mobile device
25 Cellular Base Station
30 Location Server
35 W.A.P. Gateway
40 Web-Server-based, Azaan-Software Application
70 Subscribers' database
75 Translation Table, from Cell-ID to Azaan Zone
80 Look-up Tables for Each Azaan Zone, for Five times daily prayer timings
85 Algorithm for Dynamic Calculation/Notification of Prayer timings.

### Description—Main (Preferred) Embodiment

FIG. (2) shows 5 main components in the basic version for implementation of the system using cellular phones to announce/notify timings of Muslim prayers. The 5 components are:
Mobile device 20
Cellular Base Station 25
Location Server 30
W.A.P. Gateway 35
Web-Server-based, Azaan-Software Application 40

Initial 4 components are part of Wireless Service Provider's infra-structure and are thus briefly described as under:
“Mobile Device” 20 can simply be any normal cellular phone. Broadly speaking, it is any mobile hand-held device, employing the cellular wireless network for connectivity.
“Cellular Base Station” 25 is the transmission and reception equipment including the base station antenna, which connects a cellular phone to the network.
“Location Server” 30 is a back-end computer system at Network carrier's facilities, which maintains dynamically updated database of connected subscribers' geographical locations.
“W.A.P. Gateway” 35 is another back-end computer system at Network carrier's facilities, which provides access to the internet using Wireless Application Protocol (W.A.P.)
Azaan-Software (WML) application 40 is the core of the devised system and is described hereby in detail.

“Web-Server-based, Azaan-Software Application” 40 has following sub-components, as depicted in FIG.(3):
(i) Subscriber's database 70
(ii) Translation Table, Cell-ID to Azaan Zone 75
(iii) Look-up Tables 80 for Each Azaan Zone, for Five times daily prayer timings, through out the Year
(iv) Algorithm 85 for Dynamic Calculation/notification of Prayer timings.

### Operation—Main (Preferred) Embodiment

Location Based Service or LBS, is the ability to find the geographical location of a mobile device and provide services based on this location information.

My system primarily relies on a Web-Server-based, Azaan-Software Application 40, which can interact with a mobile device 20 through a W.A.P Gateway 35. Wireless Application Protocol (W.A.P.) allows modern cell-phones to connect to World-Wide-Web through a “special computer system” located at the “Cellular Network Provider's Network Traffic Management facilities” which are often referred as “carrier infra-structure”. This “special computer system” is called the “W.A.P gateway” 35. These facilities also house another computer system called “Location Server” 30, which maintains a database of current locations, including Cell IDs, of all mobile-cellular users connected to the network. This database keeps getting updated in real-time.

“Cells” are typically spaced around 1-2 miles apart but can be spaced up to 20 miles apart. A typical Azaan-neighborhood is also around 15-20 miles in radius, which means Azaan-timings within this radius can be estimated to remain un-changed. Therefore, the location parameter of “Cell ID” has been found to provide sufficient precision for Azaan-timings calculation purposes. However, for the purposes of future growth, it has been found convenient to divide whole service area into “Azaan-Zones” whereby One Azaan Zone will contain one-or-more-adjacent cells. This will significantly reduce the number of look-up tables, and will as well enhance the speed of operation.

Another reason for using “Cell ID” is that all type of cellular network technologies keep record of current “Cell ID” of their connected subscribers, and thus no modification in the mobile handset or in the cellular network will be required to implement my Azaan-notification system.

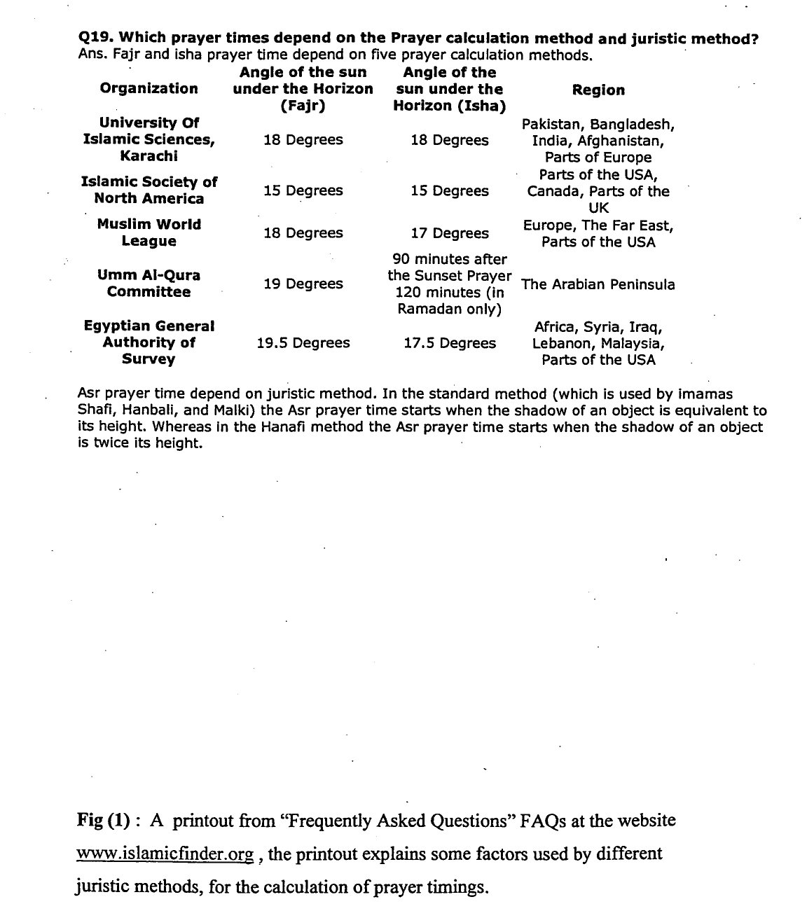

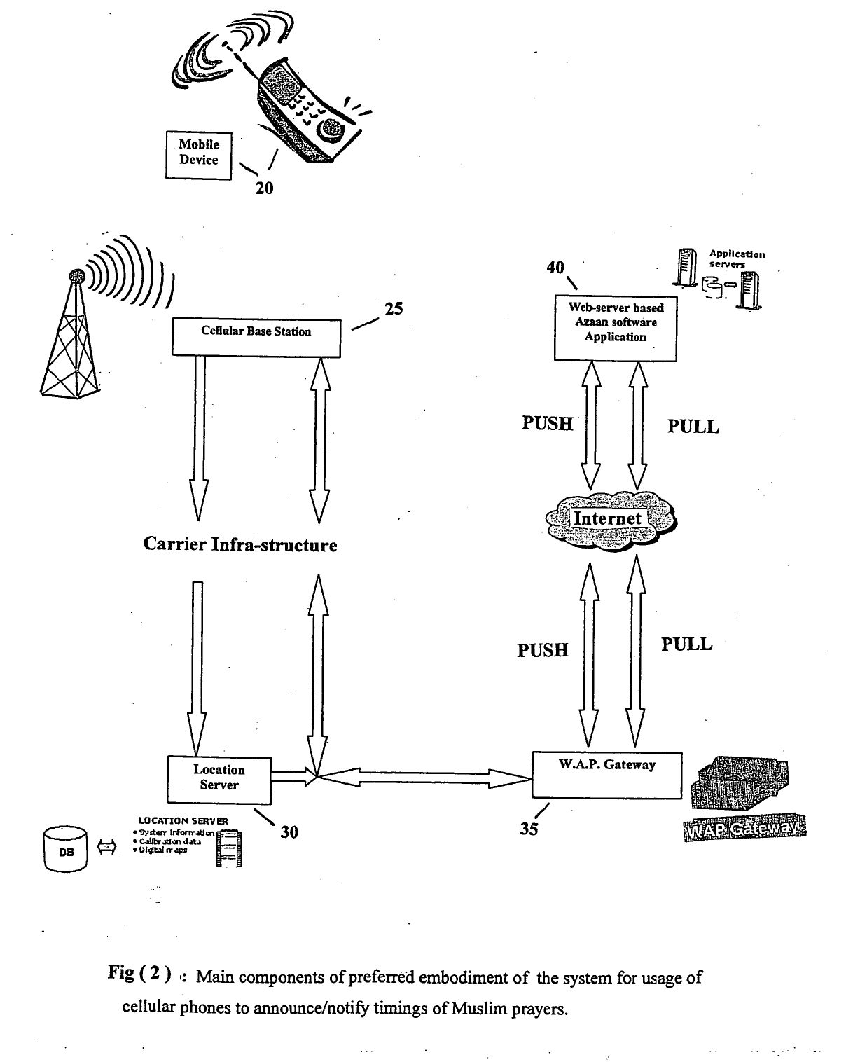

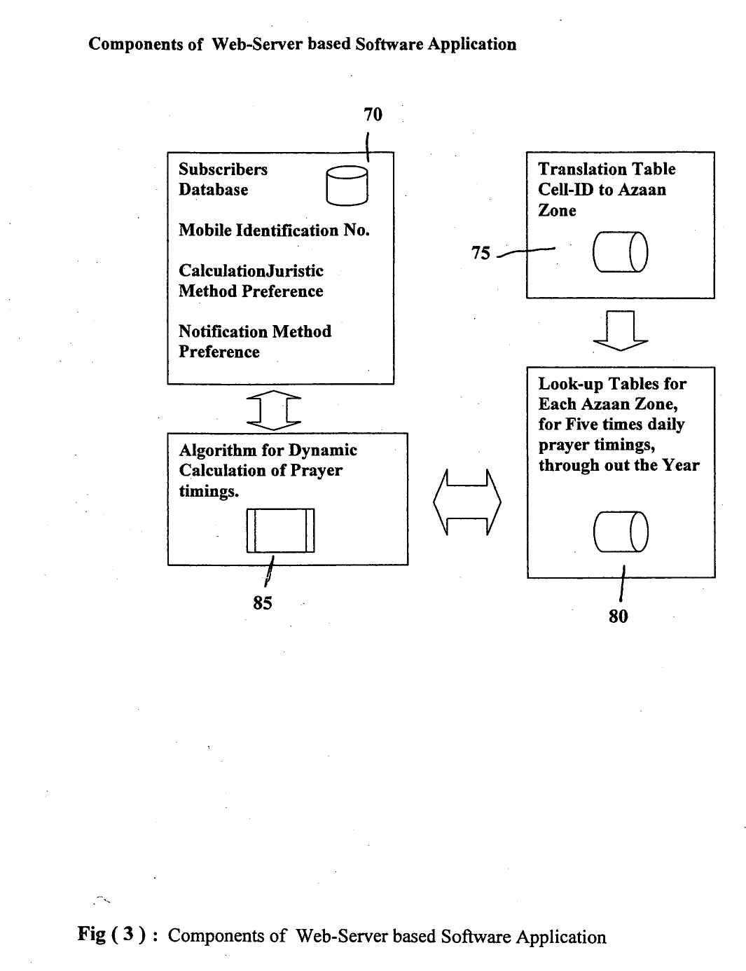

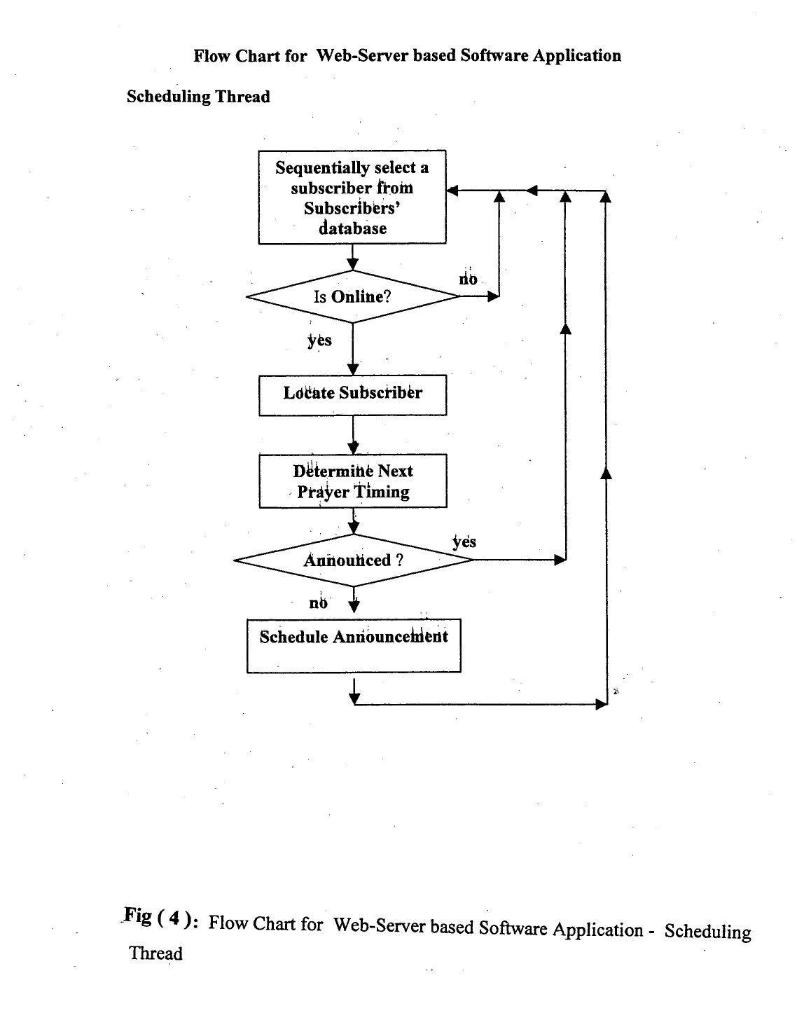

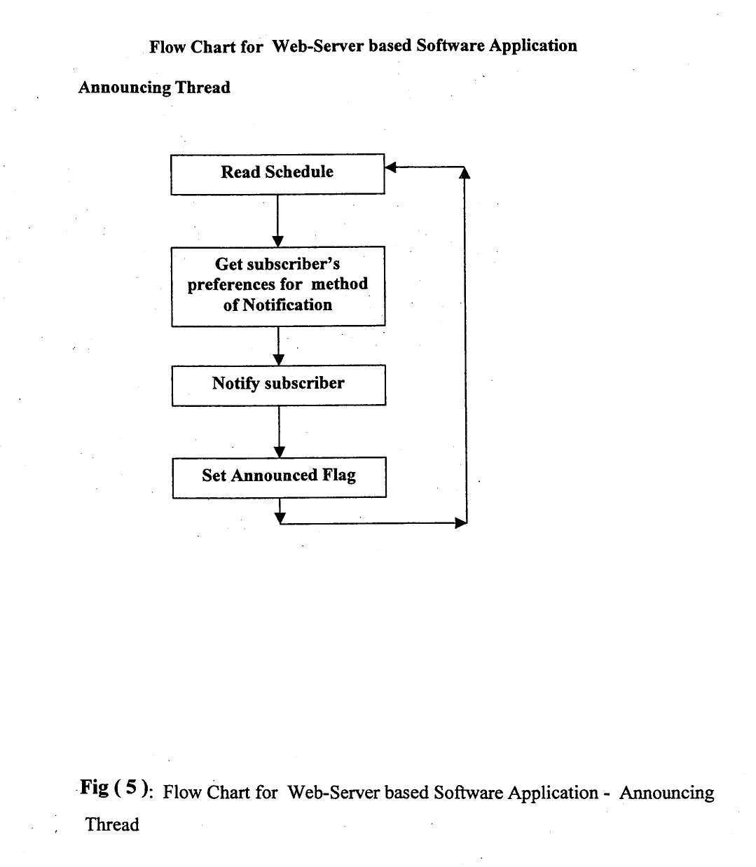

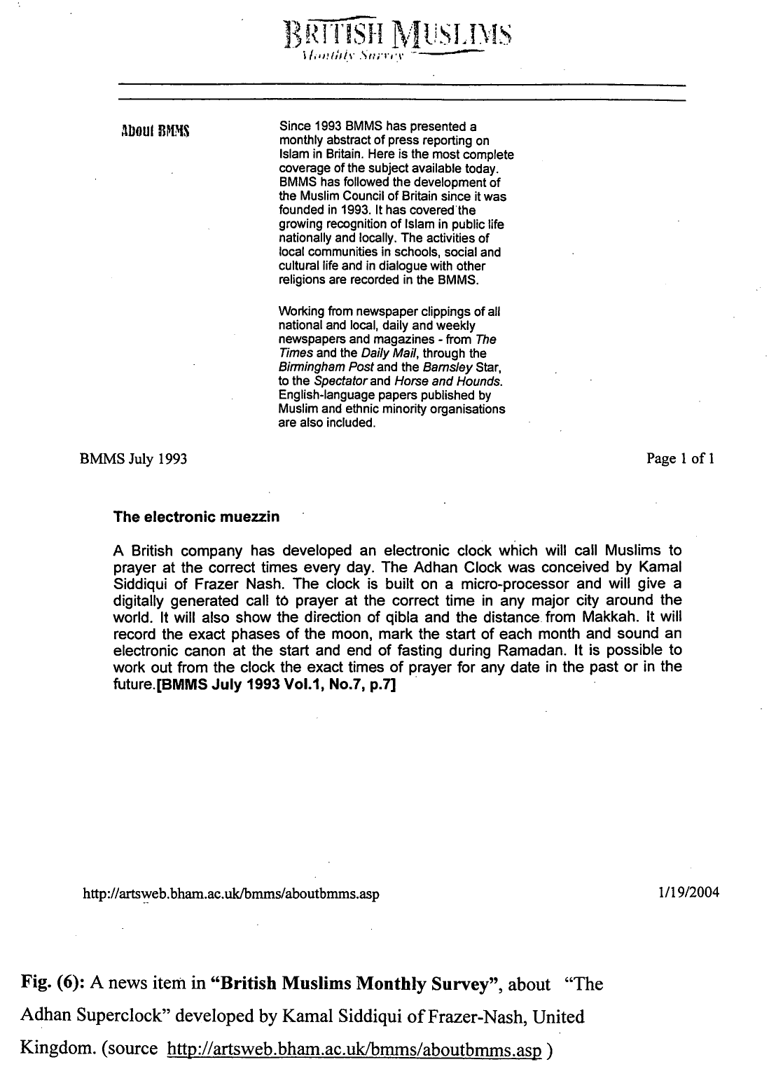

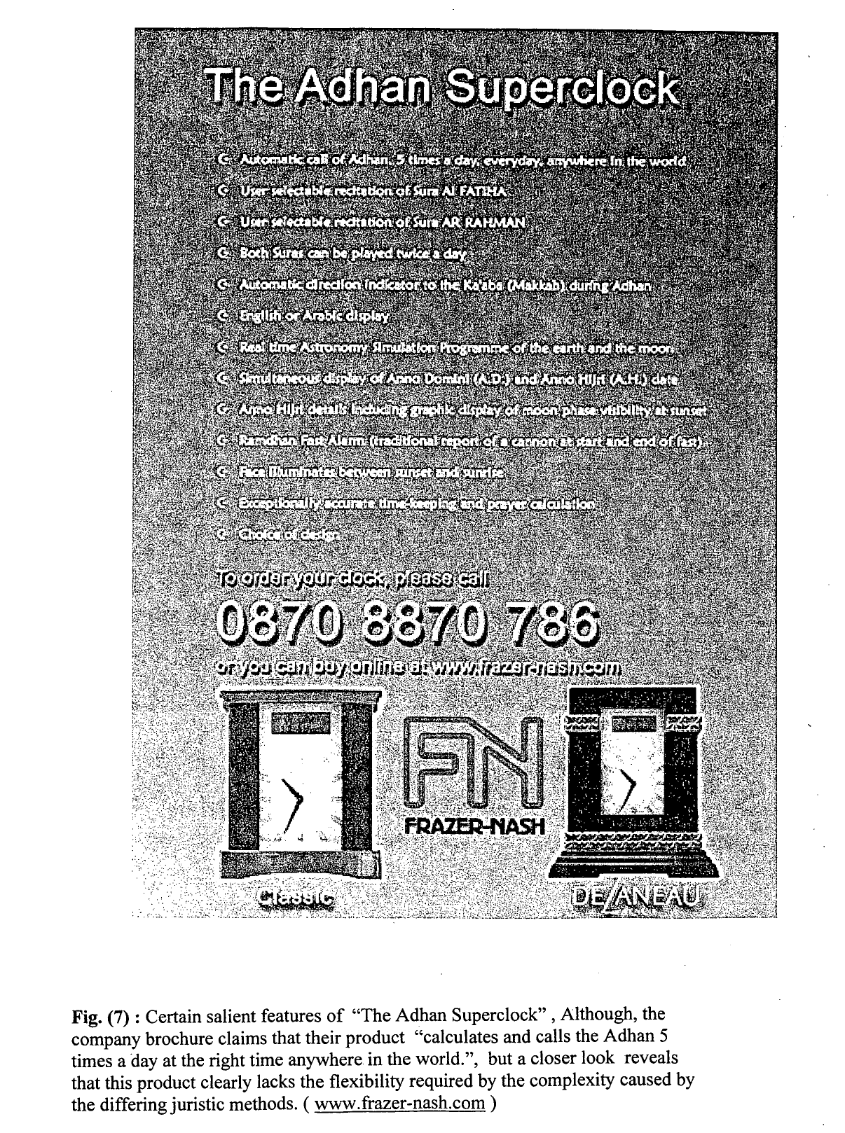

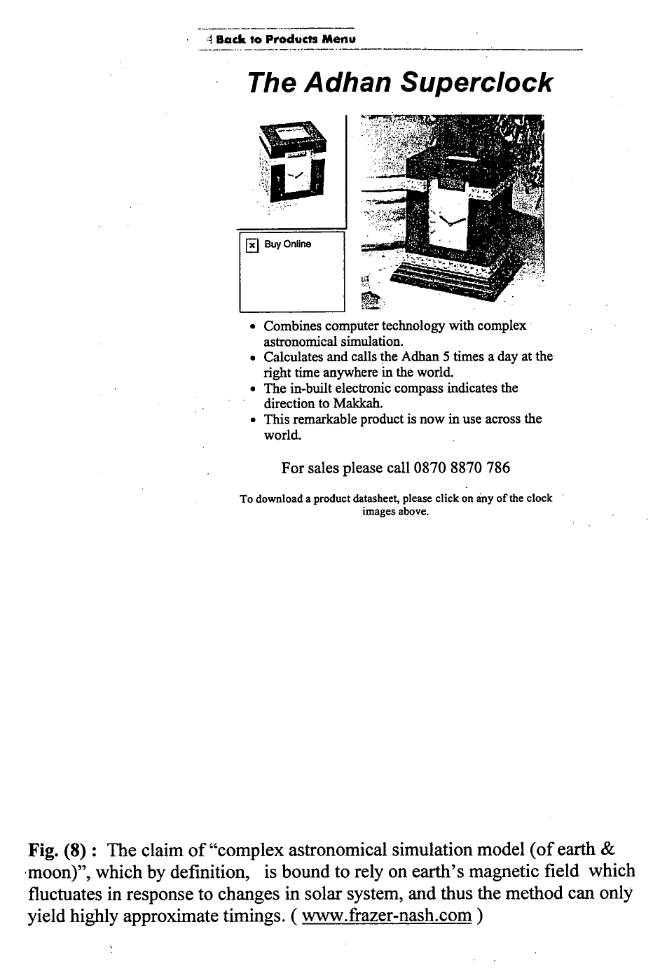

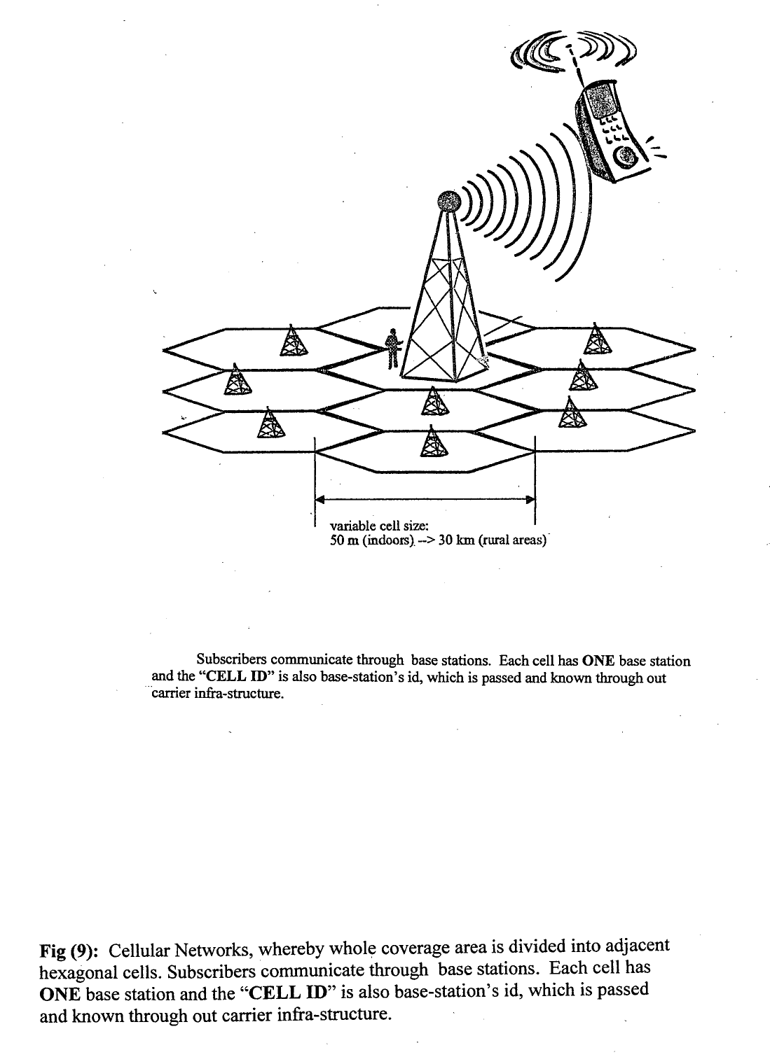

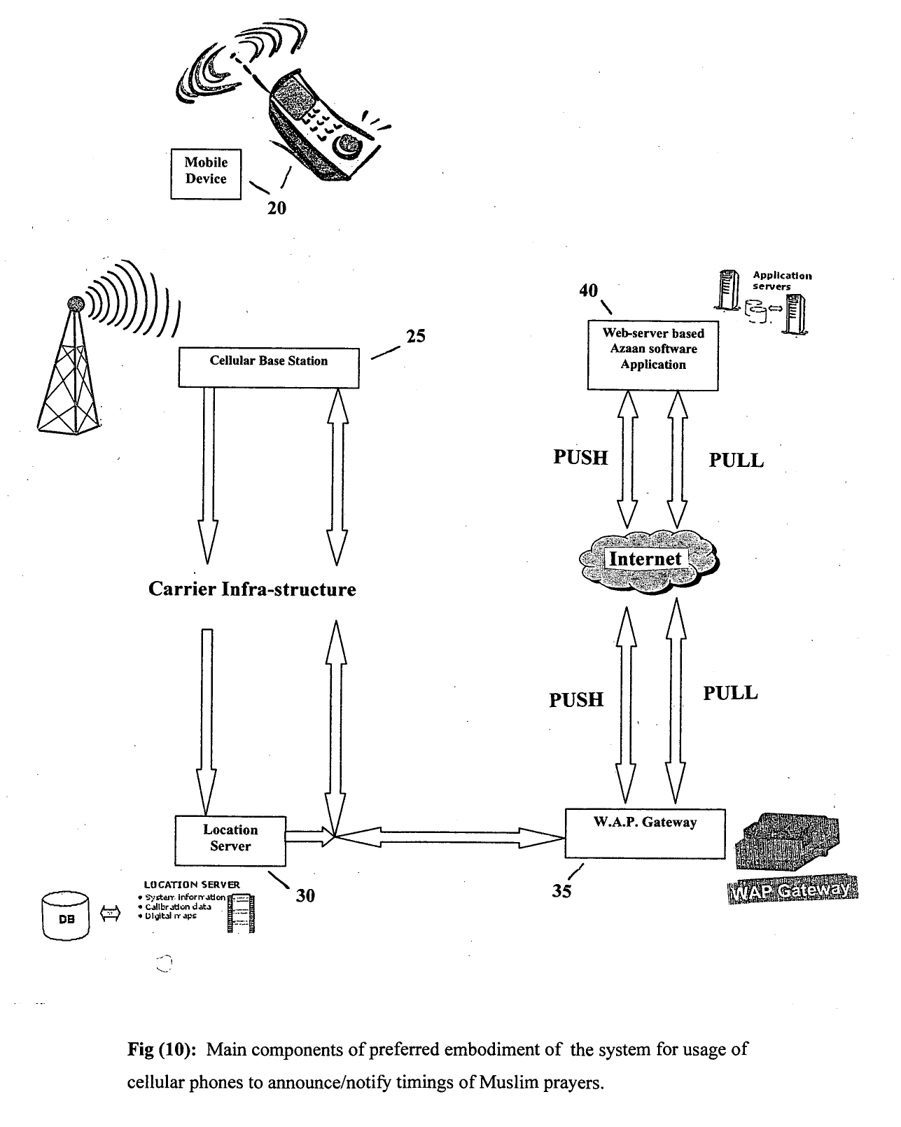

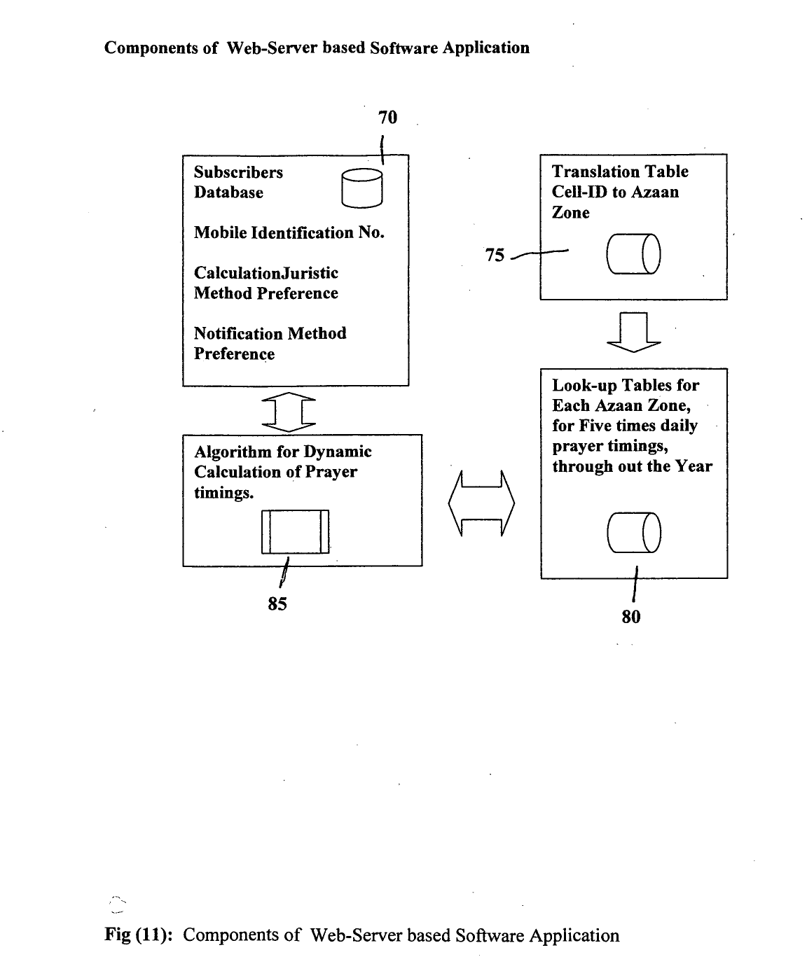

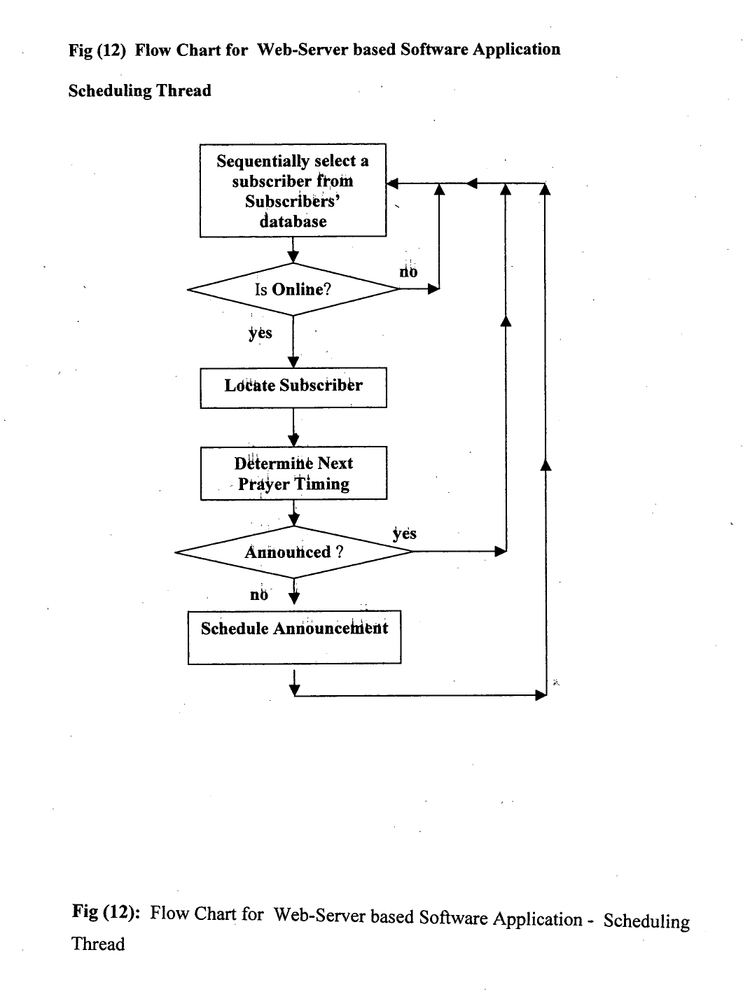

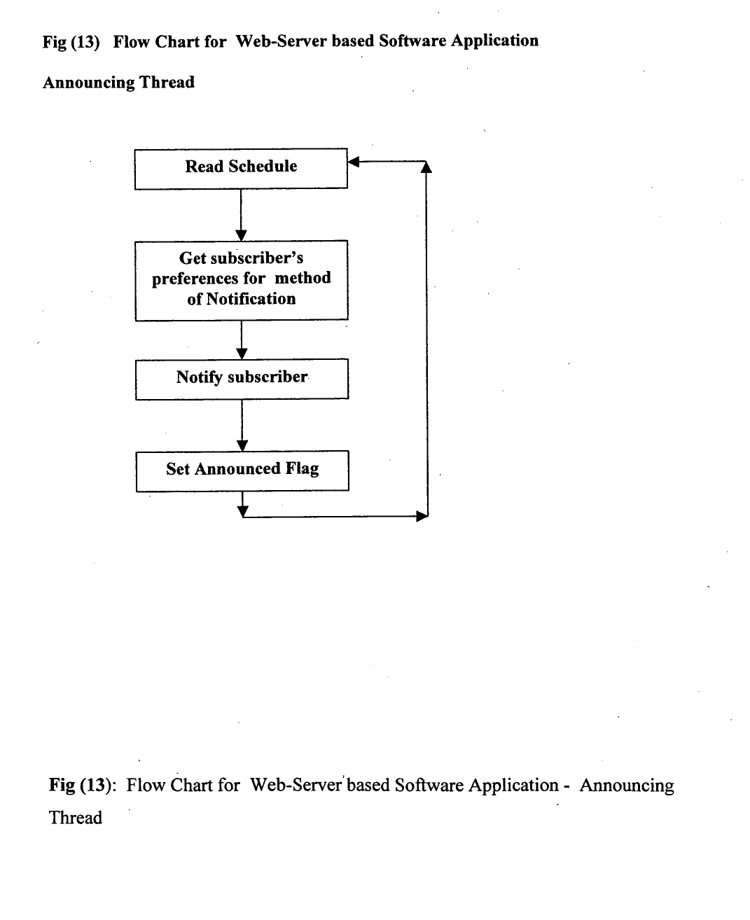

FIG. (2) depicts the main components of my system. The interaction between the components is described as under:
1. User of the Mobile Device 20 can subscribe to Azaan-service either thru the micro-browser at the mobile device 20 or at the Azaan Service Provider's Website which hosts the “Web-Server-based, Azaan-Software Application” 40. This Website also maintains a Subscribers' Database 70 containing user profiles (Mobile Identification Number MIN, & System Identification SID). The subscriber may also specify his/her preferences among several timing-calculation juristic methods.
2. Upon subscription, the Mobile-Device 20-user who has now become Azaan-Subscriber, is given a choice to download a multi-media application file containing Azaan.
3. The “Web-Server-based, Azaan-Software Application” 40 is a multi-threaded application which simply means that more than one processes can run within the application. In this case our Software Application 40 has two threads namely:
   i. Scheduling Thread (elaborated in Flow Chart of FIG. 4)
   ii. Announcing Thread (elaborated in Flow Chart of FIG. 5)
4. Scheduling Thread (FIG. 4) periodically selects subscribers from the Subscribers' Database 70 and consult the Location-Server 30 to check if the selected Mobile Device 20 is connected to the network. If the subscriber is offline, next subscriber is selected from the database 70. Updated, current locations (Cell ID's) of connected subscriber's Mobile Device 20 are passed to an “Algorithm for Dynamic Calculation/notification of Prayer timings. 85”
5. Through an intelligent frequency adjusting technique, the consultation to the Location Server 30 becomes more frequent as the Azaan time nears.

6. Cell IDs are translated into Azaan Zones through a set of pre-determined Translation Tables 75.
7. Azaan-timings for each Azaan Zones are stored in another set of pre-calculated look-up tables 80. Alternately, Azaan timings are calculated dynamically thru many of the readily available software mentioned as the prior art.
8. Wireless Application Protocol provides for PUSH mechanism whereby multi-media file can be pushed on mobile device 20 without prior interaction from the mobile-user. The mechanism is very similar to SMS (short messaging service) which is widely used for short text message. The PUSH mechanism works through Push-Proxy-Server (P.P.S.) over Push Access Protocol (P.A.P.)
9. The announcing thread FIG (5) keeps on checking the list of scheduled Azaan-announcements. At the exact local-time of Azaan, the mobile device 20 user is notified thru PUSH, Short Message Service (SMS), or similar mechanism, which operate thru the W.A.P. Gateway 35. Depending upon the user preferences stored in the profile at the Subscribers database 70, either a multi-media file or a text message will be pushed on the subscriber's mobile device.
10. If the subscriber has already downloaded a multimedia application containing a favorite recital of Azaan, then the PUSH mechanism will also provide for sending a notification which will start that previously-downloaded multimedia application.
   Advantages:

From the description above, it has become evident that my Azaan-notification System has following advantages over prior art:
No manual input is required because location parameters are detected by the system and are known through out the system.
It uses the existing equipment of cellular phone, without any modification. So there is no need to carry another equipment solely for Azaan-notification purpose.
It can provide highly personalized service because most of the logical functionality is implemented at the web-server based software application which can easily adapt after accessing user-preferences from Subscribers database.
Different juristic methods can also be supported due to flexible implementation of logic in software application
The system uses existing cellular technology which are designed to operate on very low power consumption.
Cells & Azaan Zones are very much comparable in size, and thus the system is capable of providing accurate timings.
If required, my system can easily be modified to used more precise location parameters like G.P.S. which can pin-point a mobile device within a radius of few meters.
My system uses standard time stored at the web-server, for making announcement decisions, and thus the announcement will be made at the right time, even if the subscriber is not keeping the right local time.

### Description and Operation—Alternate Embodiments

(i) On Demand Info: In addition to regular announcements of azaan at specific times, a user shall be able to run a small application on the hand-held device, which will inform user of the timings of next & previously-announced Azaan. This is a very short application which will consult the Azaan Service Provider's WML-website to get the information. Thus this application will essentially contain a shortcut to the URL of our WML-website.
(ii) Stand-alone version: This will not need any access to world-wide-web. If memory constraints permit, a stand-alone version of this application will be downloaded on the mobile-device which will calculate the Azaan-timings without consulting the WML-website. Presently, even the most capable P.D.As like Handspring Treo 600 will not be able to store an application with such an elaborate algorithm. However, reduced cost and further miniaturization of memory, make this a real possibility in near future.
(iii) Application Language: W.A.P. is still a nascent technology. Wireless Markup Language (WML) is a subset of XML (Extensible Markup Language), and is presently used widely for writing applications for communicating thru W.A.P. Gateway. However, other languages, and other subsets of XML are also getting popular in this field of software applications. SGML (Standardized Generalized Markup Language), HDML (Handheld Device Markup Language), WMLScript (WAP version of Java Script), J2ME (Java 2 Micro Edition), are just the few names to mention. Beside these, the said software application can be written in many other languages like C, C++ or Java, etc. However, for simplicity sake, the previously mentioned subsets of XML are more likely to be used in future wireless applications. Future development in software techniques are expected to enhance the ease of implementation.
(iv) P.C. with G.P.S.: Now-a-days more and more Personal Computers and Laptops are being equipped with global positioning system (GPS). As an alternate embodiment, the system may use a general purpose computer like a desktop or laptop computer for the purposes of storage and implementation of calculation algorithm while the location parameters are fed through some location detecting device like commercially available G.P.S. receivers.
(v) Cars with G.P.S.: Large transportation companies have long used Global Positioning System for fleet management. More recently Car Rental companies have started using G.P.S, and now many high-end private cars also come with G.P.S. aided navigation guidance systems. Similar system can be easily devised for real-time announcement/notification of location-dependent timings of Muslim prayers. Indeed, this system will have great potential not only in Middle Eastern automobile markets, but also in remote locations where it is impossible to have Azaan notification. Indeed, in this situation, it may be a stand-alone application, and the software may be embedded into the automobile's firmware thru some kind of flash memory or (EEPROM) Electronically Erasable & Programmable Read Only Memory.
(vi) iMode: The system & method may use the Japanese technology of iMode or some other equivalent technology instead of WAP-gateway. In iMode, the mobile device communicates to the Internet, directly, i-e without the help of gateway. Similarly, in Europe, WAP-Gateway is implemented differently as it is considered to part of World Wide Web, while in U.S.A., the Wireless Service Provider (WSP) maintains the WAP-Gateway and is situated within the WSP's infra-structure. The Azaan system allows the use of all types of wireless connectivity technologies which are yet to be evolved.
(vii) Location Technology: My Azaan-notification system uses Cell ID (Cellular Network's Base Station's Identity number), as the location parameter, but it will work equally well with other cellular location technologies like GPS (Global Positioning System), AGPS (Assisted Global Positioning System), AFLT (Advanced Forward Link Trilateration), EOTD (Enhanced Observed Time Difference), TDOA (Time Difference Of Arrival), AOA (Angle Of Arrival), and EFLT (Enhanced Forward Link Trilateration).
(viii) Network Technology: My Azaan-systems main functionality is implemented in software, and thus it has become almost independent of the network technology. With minimal efforts, my system can be modified to work with old & new systems alike. Even non-wireless networks like POTS (Plain Old Telephone System) or PSTN (Public Switched Telephone Network) can be used to work with my adapted system. While, almost no modification will be required to work with existing wireless communication technologies like AMPS (Advanced Mobile Phone Service), GSM (Global System for Mobile Communication), TDMA (Time Division Multiple Access), FDMA (Frequency Division Multiple Access), CDMA (Code Division Multiple Access), GPRS (General Packet Radio Service), UMTS (Universal Mobile Telecommunications System) and IDEN (Integrated Digital Enhanced Network).

### Conclusion, Ramification, and Scope

Accordingly, the reader will see that my “Azaan-notification system” envisages a new use of existing cellular phone technology and require minimal modification to the existing facilities.

Furthermore, the system may be used to provide other community-based information like religious festivals dates which depend upon the local sighting of new moon. Location of nearby mosques and information about other congregational facilities is also required for several yearly festivals when rituals are performed in large groups.

Muslims also follow a very strict dietary code, and the restaurant which serve these food call themselves as “Halal” or “Islamic-kosher” food restaurants. Through my Azaan-notification system, the subscribers may inquire about the nearest location of Halal restaurants and similar facilities.

1. A system to announce/notify location-specific timings of Muslim prayers, comprising:
a.) a wirelessly connected, mobile, electronic device capable of:
(i) dynamically communicating its current geographical location parameters
(ii) announcing said prayer timings after receiving appropriate electronic signal
b.) a software application capable of:
(i) accessing said location parameters of said device to determine said location-specific timings of said prayers
(ii) making real-time decision to announce said prayer timings
(iii) sending said electronic signal to said device to initiate announcement/notification of said prayer timings
Whereby said electronics device will dynamically announce/notify said location-specific timings at all locations, automatically adjusting to new timings for new locations, without having to manually enter any location identifying data.

2. The system as recited in any preceding claim, wherein the said wirelessly connected, mobile, electronic device is selected from the group consisting of mobile phones, location-aware wirelessly connected personal digital assistant (PDAs), handheld personal computers (Palm PC's), Tablet PC's, and Pocket P.Cs.

3. The system as recited in any preceding claim, wherein the said geographical location parameters are calculated from methods selected from the group consisting of Cell ID (Cellular Network's Base Station's Identity number), GPS (Global Positioning System), AGPS (Assisted Global Positioning System), AFLT (Advanced Forward Link Trilateration), EOTD (Enhanced Observed Time Difference), TDOA (Time Difference Of Arrival), AOA (Angle Of Arrival), EFLT (Enhanced Forward Link Trilateration).

4. The system as recited in any preceding claim, wherein the said electronic signals are communicated over the network technology selected from the group consisting of AMPS (Advanced Mobile Phone Service),GSM (Global System for Mobile Communication), TDMA (Time Division Multiple Access), FDMA (Frequency Division Multiple Access), CDMA (Code Division Multiple Access), GPRS (General Packet Radio Service), UMTS (Universal Mobile Telecommunications System) and IDEN (Integrated Digital Enhanced Network).

5. The system as recited in any preceding claim, wherein the announcement/notification is through textual message.

6. The system as recited in any preceding claim, wherein the announcement/notification is through recorded or unrecorded audio/visual announcement.

7. The system as recited in any preceding claim, wherein the calculation and/or announcement algorithm is stored on remotely-connected computer.

8. The system as recited in any preceding claim, wherein the calculation and/or announcement algorithm is stored on the mobile device.

9. A method to announce/notify location-dependent timings of Muslim prayers, for use in a wireless telecommunications system comprising the steps of:
determining the location of a mobile device in the said wireless telecommunication system;
determining/calculating said location-dependent timings at the location of said mobile device;
and, announcing/notifying the said timings to the user of said mobile device at the specifically determined/calculated timings of the said prayers.

10. The method as recited in claim 9, wherein said location-dependent timings are looked-up from a pre-calculated location-specific table.

11. The method as recited in claim 9, wherein said location-dependent timings are dynamically calculated from said mobile device's location parameters as known by the said wireless telecommunication system.
